(19) United States
(12) Patent Application Publication
(10) Pub. No.: US 2026/0310035 A1
(43) Pub. Date: Oct. 8, 2026

(54) E-PAPER DISPLAY PANEL FOR A PASSENGER CABIN IN AN AIRCRAFT

(71) Applicant: Diehl Aerospace GmbH, Ueberlingen (DE)

(72) Inventors: Dirk-Achim SCHEVARDO, Röthenbach (Haimendorf) (DE); Benjamin ETTENHUBER, Feucht (DE)

(73) Assignee: Diehl Aerospace GmbH, Ueberlingen (DE)

(21) Appl. No.: 19/636,047

(22) Filed: Apr. 1, 2026

(30) Foreign Application Priority Data
Apr. 4, 2025 (DE) 102025113368.9

(51) Int. Cl. G02F 1/1675; G02F 1/1333; G02F 1/167

(52) U.S. Cl. CPC G02F 1/1675; G02F 1/167; G02F 1/133305

(57) ABSTRACT

A display panel 1 for a passenger cabin in an aircraft, which is configured in the manner of an electronic paper, wherein the display panel comprises a particle layer 2, which has a viewing side 3 and a rear side 4 opposite the viewing side 3, and wherein the display panel 1 has a front layer 5, which covers the particle layer 2 on the viewing side 3, the particle layer 2 and the front layer 5 extending extensively over the entire display panel 1. The display panel 1 further comprises a control layer 6, which is arranged on the rear side 4 of the particle layer 2. The control layer 6 consists of a plurality of separately driveable shape portions 7a-i and at least one display portion 8a, b, c, the shape portions 7a-i respectively having a shape surface 12a-i and the display portion 8a, b, c being divided into a plurality of separately driveable pixel portions 13b, c, the pixel portions 13b, c respectively having a pixel surface 14b, c and each of the shape surfaces 12a-i having an area which is larger by a factor of at least ten than each of the pixel surfaces 14b, c.

### BACKGROUND OF THE INVENTION

The present invention relates to the display of display contents in a passenger cabin in an aircraft.

### DISCUSSION OF THE PRIOR ART

Electronic paper, also known as e-paper, allows energy-efficient representation of text and graphics. E-paper technology is based on microcapsules, which contain pigments in a liquid and are moved by electric fields in order to represent images and texts without backlighting. In comparison to conventional displays, e-paper requires energy only when changing the representation. The technology is employed for example in e-book readers, digital price labels and information displays. Because of the high legibility under direct incidence of light and the low power consumption, e-paper technology is a promising future technology in various fields of application.

### SUMMARY OF THE INVENTION

The present invention is directed to improvements in respect of the display of display contents in a passenger cabin in an aircraft.

More specifically, the present invention is directed to a display panel for a passenger cabin in an aircraft, wherein the display panel is configured in the manner of an electronic paper, having (1) a particle layer, which has a viewing side and a rear side opposite the viewing side, (2) a front layer, which covers the particle layer on the viewing side, the particle layer and the front layer extending extensively over the entire display panel, and (3) a control layer, which is arranged on the rear side of the particle layer, wherein the control layer consists of a plurality of separately driveable shape portions, the shape portions respectively having a shape surface; and at least one display portion, which is different from shape portions, the display portion being divided into a plurality of separately driveable pixel portions, the pixel portions respectively having a pixel surface; each of the shape surfaces having an area which is larger by a factor of at least ten than each of the pixel surfaces.

The display panel is configured to be arranged, or installed, in the interior of a passenger cabin of an aircraft. In particular, the display panel is configured to form a visible surface of the passenger cabin or to be installed, or arranged, on a visible surface of the passenger cabin. Preferentially, the display panel is configured to be installed, or arranged, over a large area on a roof region and/or wall region of the passenger cabin.

The display panel is configured in the manner of an electronic paper, also known as e-paper. The display panel is configured for the display of display contents. Here, in particular, the technologies “Prism3”, see for example “https://www.eink.com/upload/2024_10_18/3_20241018080408bxcsgx81p0.pdf” (accessed on Feb. 4, 2025) and “Gallery plus”, see for example “https://www.eink.com/brand/detail/Gallery_Plus” (accessed on Feb. 4, 2025), both from the company E Ink, may be used.

The display panel has a particle layer, the particle layer being configured extensively. The particle layer comprises a multiplicity of particles. The particles are in particular configured as coloured particles, or colour pigments. The particle layer comprises particles of at least two different colours. The particle layer is configured in the manner of the particle layer of an e-paper display, or in the manner of the image-generating layer of an e-paper display. For example, some of the particles may be configured as black particles, or pigments, and the remainder of the particles as white particles, or pigments. In particular, the particle layer also has a multiplicity of capsules, the respective capsules containing a fluid and a plurality of the particles respectively being present in the fluid. Further, the particle layer is preferentially configured so that capsules lie close together, or each capsule is surrounded by a plurality of further capsules and is in direct contact with them. In particular, the capsules are configured so that they respectively contain a plurality of particles of a respective colour.

The particle layer has a viewing side and a rear side opposite the viewing side. The particle layer is configured so that the display contents can be generated, or displayed, on the viewing side of the particle layer. The display contents are generated, or displayed on the viewing side of the particle layer by the particles, in particular by different arrangement of the particles of a respective colour.

The display panel also has a front layer, which covers the particle layer on the viewing side. The front layer is configured extensively. The front layer is in particular configured as an electrode consisting of a transparent electrically conductive material, for example indium tin oxide (ITO). In particular, the front layer may be applied, or arranged, directly on the particle layer. The particle layer and the front layer extend extensively and in particular also continuously and without interruption over the entire display panel.

The display panel furthermore has a control layer, the control layer being arranged on the rear side of the particle layer. In particular, the control layer may be arranged, or applied, directly on the particle layer. The control layer is adapted to arrange the particles of the particle layer so that display contents can be generated, or represented, on the viewing side of the particle layer. For example, in this way the particles may be arranged on different planes, in particular with the particles of a respective colour being arranged in the capsules on a respective plane between the viewing side and the rear side.

The control layer contains two mutually separate, or distinct, types of regions. Each of the first regions is formed by at least one separately driveable shape portion. Overall, however there are a plurality of shape portions. A respective one of the regions may contain one or more of the shape portions. A respective second region is formed by a respective display portion. The control layer thus consists of a plurality of separately driveable shape portions and at least one display portion. The shape portions and display portions thus do not overlap, i.e. they do not cover common surface regions. In particular, however, the shape portions and display portions adjoin one another without gaps. The shape portions respectively are formed in particular as an extended electrode, each of the electrodes and therefore each of the shape portions being separately driveable. Thus, each of the shape portions per se can only be driven in its entirety. In particular, the respective electrodes may also be formed from a plurality of individual electrodes directly adjoining one another, the respective individual electrodes being driveable together. The shape portions respectively are adapted to receive a particular voltage or respectively different voltages. In particular, a plurality of shape portions may respectively be adapted to receive the same voltage. The voltages may respectively be positive or negative.

The at least one display portion is divided into a plurality of separately driveable pixel portions. The display portion is configured so that the respective pixel portions respectively can receive at least two different voltages independently of one another. The display portion may in particular be configured so that at least two of the pixel portions can receive different voltages. In other words, this means that a first pixel portion may receive a first voltage and at least one second pixel portion may receive a second voltage, the first voltage being different from the second voltage. The pixel portions are in particular configured as electrodes, or electrode portions.

The shape portions and the pixel portions of the at least one display portion respectively are used to generate a respective electric field which influences, or arranges, the particles in the particle layer so that display contents can be represented on the viewing side of the particle layer. The shape portions may be present in particular as individual elements, which are preferentially arranged so that at least one side respectively of one shape portion respectively adjoins at least one side of at least one further shape portion, or is arranged at a short distance. The at least one display portion is in particular arranged so that it adjoins with at least one side respectively at least one side of one or more further shape portions, or is arranged at a short distance. Preferentially, the at least one display portion is arranged so that it adjoins at least one shape portion on each side, or is arranged at a short distance.

The shape portions respectively have a shape surface and the pixel portions respectively have a pixel surface. The shape surface is the surface of the respective extensively configured shape portions. The shape surface is that surface of the respective shape portions which faces towards the rear side of the particle layer or is in direct contact with the rear side of the particle layer. The pixel surfaces of the respective pixel portions are surfaces which generate an electric field by the energising of the respective pixel portions. In particular, the pixel portions may respectively comprise, or be configured as, at least one separately driveable extended electrode, the pixel surface of the respective pixel portions being the surface of the respective electrode or of the respective electrodes.

The shape portions and the at least one display portion may respectively be formed from one or more materials, at least one of the materials inducing an electrical conductivity at least at the shape surfaces and pixel surfaces.

The shape surfaces respectively have a surface geometry which is formed by the shape of the respective shape portions, in particular by the sides of the respective shape portions. In particular, the surface geometry results from the surfaces of the respective shape portions which are electrically conductive, or generate an electric field.

Furthermore, each of the shape surfaces is larger by a factor of at least ten (10) than each of the pixel surfaces. The area of a respective shape surface is thus substantially larger than the area of a respective pixel surface.

The shape portions or the regions of the shape portions which generate an electric field are used in particular to arrange the particles in the particle layer in an operating state of the display panel so that a geometrical shape is represented or representable as display content on the viewing side of the particle layer, the geometrical shapes respectively generated by the shape portions corresponding to the surface geometries of the respective shape surfaces, or electrode surfaces.

This offers the advantage that, besides a plurality of relatively large separately driveable regions, namely the shape portions, the display panel also has at least one high-resolution region, namely the display portion. Almost any display contents may therefore be represented on the high-resolution display portion, whereas the shape portions are used only for the representation of particular display contents. In this way, costs may be saved since the shape portions are driveable separately over a large area and this region does not require complex driving and/or interconnection.

Furthermore, the shape portions and the at least one display portion are configured so that they can be connected or are connected to at least one conductor element. The conductor elements are in particular adapted to drive the shape portions and the at least one display portion. The display panel is in particular configured so that at least two shape portions and the display portion respectively can be driven by at least one of the conductor elements. The conductor element is configured as an electrically conductive connection, for example a cable or conductive track.

In other words, the display panel thus has one or more display portions, which respectively are comparatively fine-resolution pixel displays. These displays are surrounded—in particular contiguously without gaps—by the shape portions, which do not however have common areas with the display portions, i.e. they are located outside them. The display panel is thus driveable outside the display portions only with a—comparatively (by the aforementioned factor of 10)—low resolution since each of the shape portions is only driveable its entirety—rather than for instance parts of it separately.

According to one preferred embodiment, in an operating state of the display panel, at least two of the pixel portions are driven according to a multiplex method and/or at least two of the shape portions are driven individually. The display portion in this case has at least three, in particular a plurality of electrical conductive tracks, which are arranged as rows and columns. Here, the pixel portions are configured for example as points of intersection, or regions of intersection, of the rows and columns. Alternatively, the pixel portions may respectively be configured as at least one extended electrode which is driveable via the rows and columns according to a multiplex method in the operating state of the display panel. For example, the electrical conductive tracks which form the rows and the columns and/or the electrode surfaces may be applied on a carrier material, for example a film. The carrier material in this case has a lower electrical conductivity than the electrical conductive tracks and the electrode surfaces, or is made of an electrically insulating material. For example, the display portion may be configured in the manner of a thin-film transistor which is arranged on the rear side of the particle layer. At least two of the shape portions may in this case be configured so that they respectively are driven or driveable individually in an operating state of the display panel. In this way, the at least two pixel portions may be driven individually, or separately, so that more complex display contents may be displayed on the viewing side of the particle layer. Further, the interconnection outlay and the associated costs may be minimised by individual driving of the at least two shape portions.

A point to another preferred embodiment, at least two of the separately driveable shape portions respectively have the same surface geometry. Here, at least two of the separately driveable shape portions are configured so that the respective surfaces, or their geometries, correspond to one another. In an operating state, the particles on the viewing side of the particle layer may therefore be arranged by the at least two shape portions so that two equal geometries are displayed as display content. In this way, for example, a repeating pattern may be represented on the viewing side of the particle layer.

As an alternative or in addition thereto, at least two of the separately driveable shape portions are configured so that they respectively have a different surface geometry.

In this case, for example, it is also possible that all the shape portions have the same surface geometry or all the shape portions respectively have different surface geometries.

In an alternative example, at least two of the separately driveable shape portions have the same surface geometry and at least two of the separately driveable shape portions have a different surface geometry.

In one preferred example, the plurality of separately driveable shape portions are divided at least into a first subset with respectively the same surface geometry and a second subset with respectively the same surface geometry, the surface geometries of the shape portions of the first subset being different from the surface geometries of the shape portions of the second subset.

In this way, a multiplicity of different display contents, in particular a multiplicity of patterns, may be represented on the viewing side of the particle layer.

According to one possible embodiment, at least one of the display portions has the same surface geometry as at least one of the separately driveable shape portions. In particular, the pixel portions are arranged so that they span a surface which is the same as, or corresponds, to the surface geometry of the at least one shape portion. The display portion can therefore be integrated more easily into the control layer. Further, if so required, a homogeneous overall pattern may be generated on the viewing side of the particle layer in an operating state.

As an alternative or in addition, it is possible that at least one of the display portions has a surface geometry which differs from the surface geometry of at least one of the shape portions. In this way, for example, it is possible to use display portions having surface geometries which are easy to produce, or having arrangements of the pixel portions which are easy to produce, so that costs can be saved.

Preferentially, the display panel is configured so that at least one of the display portions is configured to generate a pattern on the particle layer which is the same as, or corresponds to, at least one of the separately driveable shape portions or is the same as, or corresponds to, a representation generated on the viewing side of the particle layer by at least one of the shape portions. The pattern is in this case configured at least as a representation which is generated or generatable on the viewing side of the particle layer by at least one of the shape portions in an operating state. Here, the display portion is in particular configured so that, in an operating state of the display panel, it arranges a plurality of particles on the viewing side of the particle layer so that a pattern is generated as a representation with a shape which is the same as, or corresponds to, the surface geometry of the at least one shape portion or is the same as, or corresponds to, the shape, or surface geometry, of the representation generated on the viewing surface by the at least one shape portion. In other words, this means that the display panel is configured to reproduce at least one representation, which is generated on the viewing side of the particle layer by at least one of the shape portions, in an operating state. The pixel portions are driven in an operating state of the display panel so that a plurality of pixel portions respectively generate an electric field which arranges the particles lying above in the particle layer so that a representation which has the same shape as a representation generated by a shape portion is generated on the viewing side of the particle layer. In this way, a homogeneous display content can be generated.

According to one development, the separately driveable shape portions are configured to generate a regular pattern on the viewing side of the particle layer and at least one of the display portions is configured to continue the pattern at least approximately continuously, or without interruption. The pattern generated by the shape portions is composed in particular of the representations which respectively are generated or generatable on the viewing surface of the particle layer by a shape portion in an operating state.

For example, the display portion may be configured to supplement at least one representation which is generated on the viewing side of the particle layer by a shape portion. For example, a representation which is generated by a shape portion in an operating state of the display panel may be supplemented by a representation on the particle layer, which is generated by the display portion, so that the two representations are integrated into a pattern which is represented on the display panel. As an alternative or in addition, the display portion may also be configured to generate at least one representation on the viewing side of the particle layer which is the same as, or corresponds to, one of the representations which are generated or generatable on the viewing side of the particle layer by at least one shape portion.

According to one preferred development, at least one of the display portions is configured to generate text contents and/or symbols on the viewing side of the particle layer in an operating state of the display panel. The symbols may in particular be safety symbols, for example fasten seatbelt signs, or service symbols. In particular, at least one of the display portions is configured to generate a pure text content. Preferentially, at least one of the display portions is configured to generate at least one pattern and text contents and/or symbols on the viewing side, in which case the pattern may for example be represented while being overlaid with the text contents and/or the symbols. For example, the display element may also be configured so that the text contents and/or the symbols are generated dynamically in the manner of a moving image on the viewing side of the particle layer in an operating state of the display panel. The display portion may therefore be used on the one hand as a design element and on the other hand as a type of display board for communicating information.

According to one possible embodiment, the display panel is configured to generate, or display, a colourless image, or a black-and-white image, as display content on the viewing side of the particle layer in an operating state of the display panel. Black image regions, white image regions and/or image regions which are represented in a greyscale are in this case generated. The black-and-white image is in particular configured as already described above in its shape and layout. Here, the particle layer is configured so that a multiplicity of black particles and a multiplicity of white particles are arranged in the particle layer. In particular, the particle layer has a multiplicity of capsules having respectively a plurality of black particles and a plurality of white particles. Since the driving during the generation of a black-and-white image is less complex and the structure of the particle layer is less complex, costs can therefore be saved.

According to an alternative embodiment, the display panel is configured to generate, or represent as display content on the viewing side of the particle layer, a multicoloured image. The multicoloured image is in particular configured in its shape and layout as already described above. The multicoloured image may be generated or generatable on the viewing side of the particle layer by an additional colour filter layer in an operating state of the display panel. Alternatively, the multicoloured image may be generated or generatable by particles of at least two different colours in an operating state of the display panel, each of the particles having a particular colour. Alternatively, the particle layer may also have particles of at least one colour as well as black and white particles. In this way, complex display contents may be represented on the display panel.

According to one preferred embodiment, the display panel is configured as a flexible film. The front layer, the particle layer and the control layer are in this case respectively configured to be flexible. In particular, the display panel is configured so that it can be arranged on curved surfaces and/or on or over edges. In this way, the display panel may also be integrated into passenger cabins having complex spatial geometries.

In other words, the object is achieved by a panel (display panel) having a variable-colour and variable-pattern e-paper film and an e-paper display (display portion), or display region, integrated in the e-paper film. In the e-paper film, larger zones discretely (i.e. the shape portions only respectively in their entirety) and detailed zones (the display portions embodied as a pixel display) are operated, or driven in an operating state of the e-paper film, or displayed, in the same layer structure by using a multiplexing drive method.

The e-paper display (display portion) is configured so that readable information (text contents and/or symbols) is displayed when required. When not required, the e-paper display (display portion), or the display region, is intended to appear like the normal decor film (region of the display panel on which the display content is generated by the shape portions driven separately in their respective entirety), i.e. the region of the e-paper film which is not configured as an e-paper display (display portion), or the display region. The display region (display portion) is intended to be “hidden”. This is achieved in that, by suitable driving (of the individual pixels) of the display portion, the shape or the pattern of the shape portions is continued into the display portion. In other words, the pixel representation in the display portion is used to display shape portions which are “continued” into the display portion (for example a regularly repeating pattern).

It is therefore possible to avoid the drive concept being too complex and overengineered, since only one region is high-resolution, specifically the display region (display portion), whereas the rest of the e-paper film has a low resolution (a “pixel” then corresponds to a shape portion). For example, the technologies Prism3 and Gallery plus of the company E Ink may be employed here.

Both for the decor film and for the display (display portion), or the display region, two of the three layers are identical: the upper ITO layer (front layer) and the particle layer. The contacting layer (control layer) is merely either interconnected discretely or divided into rows and columns.

The novel contacting layer (control layer), also known as a backplane, now has discrete terminals and one or more multiplexing regions (pixel portions). These regions are in turn respectively led off separately, for example via a ribbon cable.

When no information is required, the display (display portion) generates the same pattern and colours as the outer region surrounding it (shape portions). Because of the same technology, there is no visible difference between the regions, for example a colour variation, etc. The film (display panel) appears completely continuously as a decor film. If the representation of different high-resolution information, images, etc. is subsequently required, the display (display portion) can generate these. That is to say, the additional info, image, etc. instantly appears in the region of the decor film. The display (display portion) also does not have to generate the information (text contents and/or symbols) on the complete rectangular display (display portion), but may adopt the adjoining colour, contour, pattern of the decor film and represent only text etc., which leads to an even better effect. The decor pattern which is generated by the region (shape portions) surrounding the display (display portion) adjoins the display (display portion) almost seamlessly. In this way, flight information in relation to connecting flights may be represented only shortly before landing, an otherwise normal pattern being represented.

### BRIEF DESCRIPTION OF THE DRAWINGS

Further features, effects and advantages of the invention may be found in the following description of a preferred exemplary embodiment of the invention and the appended figures, in which:

FIG. 1 shows a structure of a display panel comprising a front layer, a particle layer and a control layer;

FIG. 2 shows a control layer of a display panel, having a plurality of shape portions and two display portions as well as a plurality of conductor elements;

FIG. 3 shows a display panel, a display content being generated on the display panel.

### DETAILED DESCRIPTION OF THE INVENTION

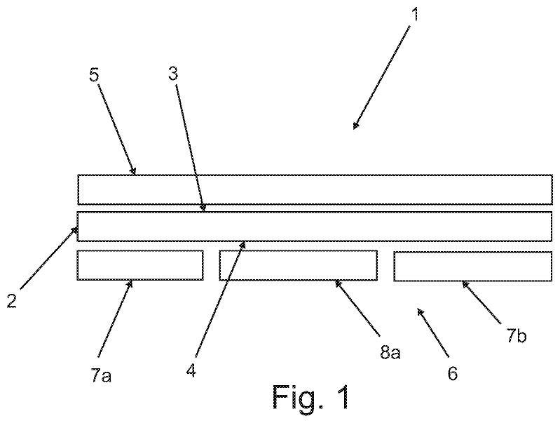

The representation in FIG. 1 shows a possible structure of a display panel in a layered fashion. The display panel 1 comprises a front layer 5, a particle layer 2 and a control layer 6. The front layer 5 is arranged above the particle layer 2 on a viewing side 3 of the particle layer 2 and the control layer 6 is arranged below the particle layer 2 on a rear side 4 of the particle layer 2. The front layer 5, the particle layer 2 and the control layer 6 respectively are configured extensively and form an extended layer stack, which forms the display panel 1 or a part of the display panel 1. The front layer 5 and the particle layer 2 are configured continuously and without interruption. The control layer 6 consists of two shape portions 7a, b driveable separately and respectively only in their entirety and a display portion 8a having separately driveable pixel portions 13a, b, the pixel portions 13a, b not being represented in FIG. 1. In other words, the display portion 8a is not only driveable in its entirety, but rather its subregions are driveable on a pixel basis in the manner of a display. The particle layer 2 comprises a multiplicity of coloured particles. The shape portions 7a, b and the display portion 8a respectively are used to generate at least one electric field so that the coloured particles of the particle layer 2 which are located above the respective shape portions 7a, b, and above display portion 8a, are arranged so that a display content can be generated on the viewing side 3 of the particle layer 2.

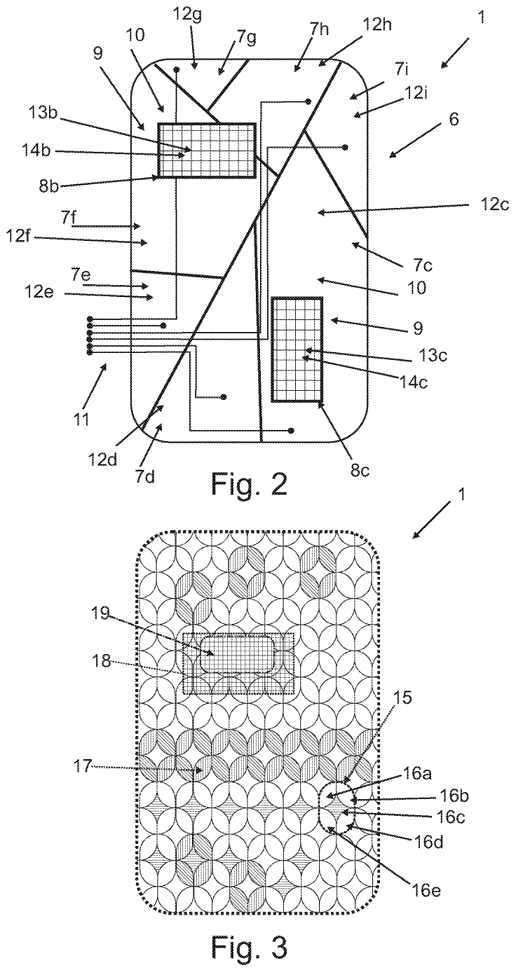

The representation in FIG. 2 shows a control layer 6 of a display panel 1. Here, the control layer 6 consists of a plurality of shape portions 7c-i (for illustration separated from one another by thickened lines) and two display portions 8b, c (for illustration bordered by thickened lines). The shape portions 7c-i and display portions 8b, c do not overlap, but rather adjoin one another without gaps. The shape portions 7c-i respectively have a shape surface 12c-i, the surface geometries of the respective shape surfaces 12 c-i being different from one another. The display portions 8b, c are arranged in the control layer 6 so that the shape surfaces 12f and 12h are partially replaced with the display portion 8b (i.e. cut out/recessed/not present there) and the shape surface 12c is partially replaced with the display portion 8c (i.e. cut out/recessed/not present there). The display portion 8b has a multiplicity of separately driveable pixel portions 13b (represented symbolically as a grid), the pixel portions 13b respectively having a pixel surface 14b. The display portion 8c has a multiplicity of separately driveable pixel portions 13c (represented symbolically as a grid), the pixel portions 13c respectively having a pixel surface 14c. Furthermore, the pixel portions 13b, c respectively are formed by rows 9 and columns 10, which are configured as electrical conductive tracks, the rows 9 and/or the columns 10 being driveable according to a multiplex method. The representation in FIG. 2 also shows a plurality of conductor elements 11, one of the conductor elements in each case respectively being connected to a shape portion. The conductor elements 11 are used for driving the shape portions 7c-i.

The representation in FIG. 3 shows a display panel 1 in the viewing direction onto a viewing side 3 of a particle layer 2, a display content being generated on the viewing side 3. The display content extends over the entire display panel 1. The display panel 1 is configured to display a display content which varies over time. The display content 1 represented in FIG. 3 is a snapshot of the time-varying display content 1. The display content has the display regions 17 and 18. The display content in the display region 17 is generated by a multiplicity of shape portions 7a-i, which are not represented in FIG. 3. The display content in the display region 18 is generated by a display portion 8a, b, c, the display portion 8a, b, c not being represented in FIG. 3. The representation in FIG. 3 shows that the display content in the display region 17 comprises a pattern of a plurality of repeating oval pattern portions 15. Each of the oval pattern portions 15 in the display region 17 consists of a plurality of pattern portion segments 16a, b, c, d. The pattern portion segments 16a, b, c, d respectively have a particular surface geometry. The pattern portion segments 16a, b, c, d and their respective surface geometry are generated by a shape portion 7a-i driveable separately, but only in its respective entirety, on the viewing side 3 of the particle layer 2. The shape portions 7a-i have a shape surface 12c-i with a respective surface geometry. Each of the respective pattern portion segments has the same surface geometry as the shape portion generating the shape surface of the pattern portion segment. In other words, this means that each shape portion generates a pattern portion segment, the surface geometry of the shape surface being the same as the surface geometry of the pattern portion segment.

The display content generated in the display region 18 by the display portion 8a, b, c has the same pattern as the pattern generated in the display region 17, the pattern in the display region 18 being generated by a multiplicity of separately driveable pixel portions 13b, c (again indicated symbolically by a grid). The pattern which is generated in the display region 17 by the respective shape portions is continued, or supplemented in the same way and following the pattern. The pattern segment portions 16a, b, c, d, e from which the pattern in the display regions 17 and 18 is formed may appear in different colours. The pattern portion segments 16a, b, c, d, e with horizontal hatching appear in a greyscale, or in grey, the pattern segment portions 16a, b, c, d, e with vertical hatching in blue, the pattern portion segments 16a, b, c, d, e with oblique hatching in black and the pattern segment portion 16a, b, c, d, e without hatching in white. The display panel 1 is configured so that in an operating state, or active state, particular pattern portion segments, for example a plurality of the star-shaped pattern portion segments (such as the pattern portion segment 16c), change their colour, the rest of the pattern portion segments 16a, b, d, e not changing the colour appearance. The display panel 1 is configured so that each of the pattern segments 16a, b, c, d, e respectively can represent one of the colours described.

In addition, a text and/or symbol region 19 is indicated in the display region 18 by a dot-and-dash line, this region being used to generate, or display text contents and/or symbols, in which case the text contents and/or the symbols may be generated by the pixel portions 13b, c. Here, however, the pattern from the display region 17 is no longer continued. The pixel representation in the symbol region 19 is thus used only for the pixel-based representation of text/graphics/symbols.

The effect for the observer is as if a pixel display were embedded only in the symbol region 19 into the otherwise uniformly appearing surface of the display panel 1. The actual boundary of the display region 18 is thus ideally not perceptible to the observer since the pattern (simulated in the display region 18 by pixels) extends seamlessly from the display region 17 over the boundary as far as the symbol region 19.

### LIST OF REFERENCES

1 display panel
2 particle layer
3 viewing side of the particle layer
4 rear side of the particle layer
5 front layer
6 control layer
7a-i shape portion
8a,b,c display portion
9 rows
10 columns
11 conductor elements
12c-i shape surfaces
13b,c pixel portions
14b,c pixel surfaces
15 pattern portion
16a-e pattern portion segments
17 display region
18 display region
19 text and/or symbol region

What is claimed is:

1. A display panel for a passenger cabin in an aircraft,
wherein the display panel is configured in the manner of an electronic paper,
having a particle layer, which has a viewing side and a rear side opposite the viewing side,
having a front layer, which covers the particle layer on the viewing side, the particle layer and the front layer extending extensively over the entire display panel,
having a control layer, which is arranged on the rear side of the particle layer,
wherein the control layer consists of:
a plurality of separately driveable shape portions, the shape portions respectively having a shape surface;
and at least one display portion, which is different from shape portions,
the display portion being divided into a plurality of separately driveable pixel portions, the pixel portions respectively having a pixel surface;
each of the shape surfaces having an area which is larger by a factor of at least ten than each of the pixel surfaces.

2. The display panel according to claim 1, wherein in an operating state of the display panel at least two of the pixel portions are driven according to a multiplex method and/or at least two of the shape portions are driven individually.

3. The display panel according to claim 1, wherein at least two of the separately driveable shape portions respectively have the same surface geometry.

4. The display panel according to claim 1, wherein at least two of the separately driveable shape portions respectively have a different surface geometry.

5. The display panel according to claim 1, wherein at least one of the display portions has the same surface geometry as at least one of the shape portions.

6. The display panel according to claim 1, wherein at least one of the display portions has a surface geometry which differs from the surface geometry of at least one of the shape portions.

7. The display panel according to claim 1, wherein at least one of the display portions is configured to generate a pattern on the particle layer, which is the same as at least one of the shape portions or is the same as a representation generated on the viewing side of the particle layer by at least one of the shape portions.

8. The display panel according to claim 7, wherein
the shape portions are configured to generate a regular pattern on the particle layer, and
at least one of the display portions is configured to continue the pattern at least approximately continuously/without interruption.

9. The display panel according to claim 1, wherein at least one of the display portions is configured to generate text contents and/or symbols on the viewing side of the particle layer.

10. The display panel according to claim 1, wherein the display panel is configured to generate a colourless image.

11. The display panel according to claim 1, wherein the display panel is configured to generate a multicoloured image.

12. The display panel according to claim 1, wherein the display panel is configured as a flexible film.
